(19) United States
(12) Patent Application Publication
(10) Pub. No.: US 2004/0128080 A1
(43) Pub. Date: Jul. 1, 2004

(54) Clustering biological data using mutual information

(76) Inventor: Alexander M. Tolley, Los Gatos, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/609,330

(22) Filed: Jun. 27, 2003

Related U.S. Application Data
(60) Provisional application No. 60/392,500, filed on Jun. 28, 2002.

(51) Int. Cl. G06F 19/00

(52) U.S. Cl. 702/20

(57) ABSTRACT

The invention relates to clustering biological data. For example, an apparatus and method for clustering gene expression data are described. Mutual information for two or more genes can be derived, and the mutual information can be used as a metric for clustering gene expression data.

### CROSS REFERENCE TO RELATED APPLICATION

This application claims the benefit of U.S. Provisional Application Serial No. 60/392,500, filed Jun. 28, 2002, the disclosure of which is incorporated herein by reference in its entirety.

### FIELD OF THE INVENTION

The invention relates to clustering biological data. For example, an apparatus and method for clustering gene expression data are described.

### BACKGROUND OF THE INVENTION

Clustering methods can be used to identify relationships between genes of a genome. For example, clustering methods have been used to identify genes that are involved in metabolic shift of yeast (DeRisi et al. (1997) Science 278: 680-686) as well as genes that are involved in central nervous system development of rats (Wen et al. (1998) Proc. Natl. Acad. Sci. USA 95: 334-339). Clustering methods typically include two components: (1) a metric (e.g., a distance measure) that indicates the degree of similarity of two gene expression patterns; and (2) a clustering technique that uses some heuristics to identify clusters of similar gene expression patterns based on the metric.

In accordance with existing clustering methods, statistical tests or Fisher exact tests are typically used as metrics to measure dependency between two or more genes. In some instances, Euclidean distances, Euclidean angles, linear correlation coefficients, or Pearson correlation coefficients are used to determine if two or more genes are co-expressed, and results can be represented as lengths that reflect the degree of similarity between gene expression patterns. These metrics can capture similarity in “shape” but can be affected by outliers, which can distort results obtained using these metrics.

Existing clustering methods typically use clustering techniques that can be categorized as non-hierarchical techniques and hierarchical techniques. Non-hierarchical techniques can be used to cluster N objects into K clusters in an iterative process until certain goodness criteria are optimized. Examples of non-hierarchical techniques include K-means, expectation-maximization (“EM”), and auto-class techniques. The K-means technique, which is a commonly used technique for clustering, can be used to assign N genes into K clusters. In particular, K initial centroids of the K clusters can be chosen, either by a user or at random, and each gene can be assigned to a particular cluster with a “nearest” centroid. Next, the K centroids of the K clusters can be recalculated based on an average expression pattern of genes belonging to the K clusters, and one or more genes can be reassigned to a particular cluster with a “nearest” centroid. Membership in the K clusters and the K centroids can be updated iteratively until no more changes occur or until the amount of change falls below a pre-defined threshold value. In some instances, membership in the K clusters can be derived based on minimizing a sum of squared distances to the K centroids, which process can result in “round” clusters. Different random initial seeds can be tried for the K centroids to assess robustness of clustering results.

Hierarchical techniques typically cluster objects into a hierarchy of nested clusters, where each cluster can include a union of two or more smaller clusters. Hierarchical techniques are often represented by a tree. A tree can be built “bottom-up” (e.g., using an agglomerative approach) by combining various sets of gene expression patterns into larger sets. Alternatively, a tree can be built “top-down” (e.g., using a division approach) by iteratively decomposing various sets of gene expression patterns into smaller subsets.

Existing clustering methods can be time consuming and difficult to implement. Generally speaking, a greater amount of time can be required to carry out a clustering method having a greater level of robustness. For example, depending on the size of a database and on the dimensionality of data stored in the database, a relatively robust clustering method can take several hours to run. In addition, existing clustering methods, such as those using linear correlation coefficients or Euclidian distances as metrics, are often inadequate for recognizing subtle correlations between gene expression patterns and for dealing with outliers.

Attempts have been made to overcome some of the shortcomings of existing clustering methods. In particular, attempts have been made to cluster gene expression data using information theory. In accordance with information theory, gene expression data can be clustered based on mutual information. In general, mutual information M(A,B) for two variables A and B can represent how much information about variable A can be inferred based on variable B (and vice versa). In some instances, mutual information M(A,B) can be calculated using the equation M(AB)=H(A)+H(B)−H(AB), where H(A) represents an entropy associated with variable A, H(B) represents an entropy associated with variable B, and H(A,B) represents a joint entropy associated with variables A and B.

In one previous attempt using information theory (Butte and Kohane (2001) Pac. Symp. Biocomput. 418-429), a histogram of gene expression data is created. The histogram is binned to create discrete states, and binary values (e.g., 0 or 1) are assigned to the gene expression data in accordance with the discrete states. Mutual information is then calculated using the binary values to cluster the gene expression data. This application of mutual information for discrete states is similar to methods used to determine whether a base substitution within a polynucleotide sequence is a polymorphism or a mutation (U.S. Pat. No. 5,867,402 to Schneider et al.) and methods for aligning sequences (U.S. Pat. No. 6,001,562 to Milosavljevic). Gene expression, however, is typically a continuous phenomenon. As a result, partitioning a continuum of gene expression levels into bins can lead to errors and loss of information. In an attempt to overcome shortcomings associated with binning, a suggestion has been made to use a fuzzy algorithm to smooth out bin boundaries (Woolf and Wang (2000) Physiol Genomics 3: 9-15). Nonetheless, there remains a need for a clustering method that is more efficient, that is less prone to errors or loss of information, and that is capable of recognizing correlations not revealed by existing clustering methods.

It is against this background that a need arose to develop the apparatus and method described herein.

### SUMMARY OF THE INVENTION

One embodiment of the invention relates to a method of clustering genes. The method includes determining, for each condition k of n conditions, a probability pᵢₖ of a first gene gᵢ being in its induced state and a probability pⱼₖ of a second gene gⱼ being in its induced state. The method also includes deriving a contingency table for the first gene gᵢ and the second gene gⱼ based on the probabilities pᵢₖ and pⱼₖ and deriving a mutual information M for the first gene gⱼ and the second gene gⱼ based on the contingency table. The method further includes clustering the first gene gᵢ and the second gene gⱼ based on the mutual information M as a metric.

Another embodiment of the invention relates to a method of clustering genes. The method includes determining, for each condition k of n conditions, a probability pᵢₖ of a first gene gᵢ being in its induced state based on a first probability function and a probability pⱼₖ of a second gene gⱼ being in its induced state based on a second probability function. The method also includes deriving a contingency table for the first gene gᵢ and the second gene gⱼ based on the probabilities pᵢₖ and pⱼₖ and deriving a mutual information M for the first gene gᵢ and the second gene gⱼ based on the contingency table. The method further includes clustering the first gene gᵢ and the second gene gⱼ based on the mutual information M as a metric.

A yet another embodiment of the invention relates to a method of deriving a mutual information M for a first gene gᵢ and a second gene gⱼ. The method includes determining, for each condition k of n conditions, a probability pᵢₖ of the first gene gᵢ being in its induced state and a probability pⱼₖ of the second gene gⱼ being in its induced state. The method also includes deriving a 2×2 contingency table T_{ij,xy} for the first gene gᵢ and the second gene gⱼ based on the probabilities pᵢₖ and pⱼₖ, wherein x ranges from 0 to 1, and y ranges from 0 to 1. The method further includes deriving the mutual information M for the first gene gᵢ and the second gene gⱼ based on the 2×2 contingency table T_{ij,xy}.

A further embodiment of the invention relates to a method of generating a list of genes. The method includes providing a set of gene expression data associated with a plurality of genes under n conditions. The method also includes selecting a first subset of gene expression data from the set of gene expression data, the first subset of gene expression data being associated with a first gene gᵢ. The method also includes selecting a second subset of gene expression data from the set of gene expression data, the second subset of gene expression data being associated with a second gene gⱼ. The method also includes determining, for each condition k of the n conditions, a probability pᵢₖ of the first gene gᵢ being in its induced state based on the first subset of gene expression data. The method also includes determining, for each condition k of the n conditions, a probability pⱼₖ of the second gene gⱼ being in its induced state based on the second subset of gene expression data. The method further includes deriving a mutual information M for the first gene gᵢ and the second gene gⱼ based on the probabilities pᵢₖ and pⱼₖ and generating, based on the mutual information M, the list of genes indicating the first gene gᵢ and the second gene gⱼ.

A yet further embodiment of the invention relates to a computer-readable medium. The computer-readable medium includes code to determine, for each condition k of n conditions, a probability pᵢₖ of a first gene gᵢ being in its induced state and a probability pⱼₖ of a second gene gⱼ being in its induced state. The computer-readable medium also includes code to derive a contingency table for the first gene gᵢ and the second gene gⱼ based on the probabilities pᵢₖ and pⱼₖ and code to derive a mutual information M for the first gene gᵢ and the second gene gⱼ based on the contingency table. The computer-readable medium further includes code to cluster the first gene gᵢ and the second gene gⱼ based on the mutual information M as a metric.

### BRIEF DESCRIPTION OF THE FIGURE

FIG. 1 illustrates a flow chart for clustering expression patterns of genes of a genome, according to an embodiment of the invention.

### DETAILED DESCRIPTION

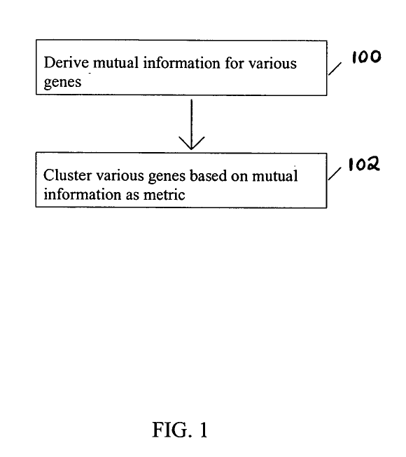

Embodiments of the invention relate to clustering biological data based on information theory. In some instances, gene expression patterns can be compared to identify relationships between genes of a genome. FIG. 1 illustrates a flow chart for clustering expression patterns of genes of a genome, according to an embodiment of the invention. The illustrated embodiment can be used for clustering expression patterns of two or more genes, such as, for example, more than 10 genes, more than 100 genes, or more than 1000 genes. Mutual information can be derived as a metric that indicates the degree of similarity of various gene expression patterns (block 100). In particular, mutual information can be derived based on a probabilistic representation of various gene expression patterns. Once derived, the mutual information can be used in conjunction with a clustering technique to identify clusters of similar gene expression patterns (block 102). In particular, various genes can be clustered based on the mutual information as a metric.

### Definitions

The following definitions apply to some of the elements described with regard to some embodiments of the invention. These definitions may likewise be expanded upon herein.

The singular forms “a”, “an”, and “the” include plural referents unless the content clearly dictates otherwise. Thus, for example, reference to “an element” includes one or more such elements.

The term “set” refers to a collection of one or more elements. Elements of a set can also be referred to as members of the set. Elements of a set can be the same or different. In some instances, elements of a set can share one or more common characteristics.

The term “biological sample” refers to a biological system or a model of a biological system. In some instances, a biological sample is capable of responding to a stimulus. Typical biological samples include, for example, individual cells, collections of cells (e.g., cell cultures), tissues, organs, multi-cellular organisms, prokaryotic organisms, populations of multi-cellular or prokaryotic organisms, and the like. For example, a biological sample can include a eukaryotic cell. Suitable eukaryotic cells include cells obtained from, for example, humans, rats, mice, cows, sheeps, dogs, cats, chickens, pigs, goats, yeasts, plants, and the like.

The term “stimulus” refers to a perturbation that can be applied to a biological sample. In some instances, a stimulus is capable of affecting a biological sample in accordance with a biological activity of the stimulus. For example, a stimulus can affect a biological sample and can induce a change in the biological sample. Typical stimuli include, for example, compounds, environmental stresses, and the like. Typical compounds include, for example, small organic molecules, such as drugs or prospective pharmaceutical lead compounds. Typical compounds can also include, for example, toxins, pollutants, dyes, flavors, herbal preparations, environmental agents, proteins, nutrients, peptides, polynucleotides, heterologous genes (e.g., in expression systems), plasmids, polynucleotide analogs, peptide analogs, lipids, carbohydrates, infectious agents (e.g., viruses, bacteria, fungi, parasites, and phages), and the like. As used herein, the term “test compound” refers to a compound of interest, and the term “control compound” refers to a compound that is used as a standard of comparison. A control compound can be used to contrast biological activities of a test compound and of the control compound. In some instances, a control compound does not share any primary biological activity with a test compound. For example, control compounds can include drugs that are used to treat diseases distinct from those treated using test compounds. Additional examples of control compounds include vehicles, known toxins, known inert compounds, and the like. Typical environmental stresses include, for example, starvation, hypoxia, temperature changes, and the like.

The terms “polynucleotide,” “oligonucleotide,” “nucleic acid,” and “nucleic acid molecule” refer to a polymeric form of nucleotides of any length, including, for example, ribonucleotides and deoxyribonucleotides. These terms can refer to triple-, double-, and single-stranded DNA, as well as triple-, double-, and single-stranded RNA. These terms can refer to naturally occurring forms as in a purified restriction digest. These terms can also refer to modified forms, such as by methylation and/or by capping, and unmodified forms of a polynucleotide. For example, the terms can refer to polydeoxyribonucleotides (e.g., containing 2-deoxy-D-ribose), polyribonucleotides (e.g., containing D-ribose), any other type of polynucleotide which is an N- or C-glycoside of a purine or pyrimidine base, and other polymers containing non-nucleotidic backbones, such as, for example, polyamide (e.g., peptide nucleic acids (“PNAs”)) and polymorpholino polymers (e.g., commercially available from Anti-Virals, Inc., Corvallis, Oreg., as Neugene). The terms can also refer to various forms that are produced synthetically, recombinantly, or by polymerase chain reaction (“PCR”) amplification. For example, the terms can refer to various synthetic sequence-specific nucleic acid polymers in which the polymers include nucleobases in a configuration that allows for base pairing and base stacking such as found in DNA and RNA.

The term “hybridize” and its grammatical equivalents refer to the coupling of polynucleotides that are sufficiently complementary to form complexes via Watson-Crick base pairing. It will be appreciated that hybridizing sequences need not have perfect complementarity to provide stable complexes. Furthermore, the ability of two polynucleotides to hybridize can be dependent on experimental conditions. For example, temperature and salt concentration can affect the percentage of complementary base pair matches required for hybrid duplexes to remain intact. Experimental conditions that favor hybridization are referred to as being less “stringent” than experimental conditions that require a greater degree of sequence complementarity to maintain a stable complex. In many situations, stable complexes will form where fewer than about 10% of bases are mismatches, ignoring loops of four or more nucleotides. Accordingly, as used herein, the term “hybridize” can refer to the formation of a stable complex between a polynucleotide and its “complement” under appropriate experimental conditions and where there is typically about 90% or greater homology.

The term “probe” refers to a structure including a polynucleotide having a nucleic acid sequence capable of hybridizing to a polynucleotide present in a target analyte. In some instances, a probe includes a polynucleotide that is at least partially complementary to a target polynucleotide to be detected. Typically, a probe is labeled so that its presence can be detected. Polynucleotide regions of probes may be composed of DNA, RNA, synthetic nucleotide analogs, or a combination thereof. Probes of dozens to several hundred bases long can be artificially synthesized using polynucleotide synthesizing machines or can be derived from various types of DNA cloning techniques. A probe can be single-stranded or double-stranded. Probes are useful in the detection, identification, and isolation of particular gene sequences or fragments. It is contemplated that a probe can be labeled with a reporter molecule, so that the probe is detectable using a detection system, such as, for example, ELISA, EMIT, enzyme-based histochemical assays, fluorescence, radioactivity, luminescence, spin labeling, and the like. As used herein, the terms “array,” “polynucleotide array,” “microarray,” “polynucleotide probe array,” and “probe array” refer to a substrate, surface, or support on which is attached or deposited a set of probes.

Alignment of polynucleotides for comparison can be performed using various methods. For example, alignment of polynucleotides can be conducted by a local homology method (Smith and Waterman, Adv. Appl. Math. 2: 482 (1981)), by a homology alignment method (Needleman and Wunsch J. Mol. Biol. 48: 443 (1970)), by a search for similarity method (Pearson and Lipman, Proc. Natl. Acad Sci. USA 85: 2444 (1988)), by computerized implementations of the foregoing methods (e.g., CLUSTAL, ClustalW, GAP, BESTFIT, FASTA, and TFASTA in the Wisconsin Genetics Software Package, available from Genetics Computer Group (GCG), Madison, Wis., USA), or by inspection. Methods for aligning polynucleotides using CLUSTAL program are disclosed by Higgins and Sharp in Gene, 73: 237-244 (1988) and in CABIOS 5:151-153 (1989).

The term “parameter” refers to a constant (e.g., an arbitrary constant) or a variable. In some instances, a parameter can be included in a mathematical expression, and the parameter can be adjusted to provide various cases of a phenomenon represented by the mathematical expression (See, e.g., McGraw-Hill Dictionary of Scientific and Technical Terms, S. P. Parker, ed., Fifth Edition, McGraw-Hill Inc., 1994). For certain applications, a parameter can represent any of a set of properties whose values determine the characteristics or behavior of a phenomenon of interest.

The term “data point” refers to information associated with a phenomenon of interest. In some instances, a data point can include a numeric value that is associated with a physical measurement (e.g., an “acquired” datum or data point) or a numeric value that is derived from a set of acquired data points (e.g., a “derived” datum or data point). Derived data points include, for example, a rate, a ratio, a logarithm of a ratio, a magnitude of change, a slope of a line (e.g., as determined by regression analysis), an intercept (e.g., as determined by regression analysis), correlation coefficients, probabilities, mutual information, contingency tables, and the like.

The term “database” refers to a collection of data points and data attributes associated with the data points. For example, a database can include acquired data points, derived data points, and data attributes (e.g., tags) associated with experiments carried out using a microarray. As used herein, a “relational” database refers to a database that includes a set of tables composed of columns and rows for organizing data points included in the database. In some instances, a set of tables and categories of a relational database can be related to one another through at least one common data attribute. The term “external database” as used herein refers to any publicly available database, such as, for example, GenBank and Blocks.

Some embodiments of invention can employ conventional methods of database formulation, storage, and manipulation. Such methods are disclosed in Numerical Mathematical Analysis, Third Edition, by J. B. Scarborough, 1955, John Hopkins Press, publisher; System Analysis and Design Methods, by Jeffrey L. Whitten, et al., Fourth Edition, 1997, Richard D. Irwin, publisher; Modem Database Management, by Fred R. McFadden, et al., Fifth Edition, 1999, Addison-Wesley Pub. Co., publisher; Modem System Analysis and Design, by Jeffery A. Hoffer, et al., Second Edition, 1998, Addison-Wesley Pub. Co., publisher; Data Processing: Fundamentals, Design, and Implementation, by David M. Kroenke, Seventh Edition, 2000, Prentice Hall, publisher; and Case Method: Entity Relationship Modelling (Computer Aided Systems Engineering), by Richard Barker, 1990, Addison-Wesley Pub Co., publisher.

The term “formulation” with reference to a database refers to collecting data points, inputting those data points into a desired database format, and associating various data attributes with the data points according to the particular database format employed. A wide variety of computer software can be used for inputting data points and associating the data points with data attributes, such as, for example, Excel® spreadsheet software (Microsoft® Corporation, Seattle, Wash.), Quattro® spreadsheet software (Corel Inc., Ottawa, Canada), Microsoft Access 2000® software (Microsoft® Corporation, Seattle, Wash.), Oracle® software (Oracle Inc., Redwood Shores, Calif.), as well as other database and data warehousing software.

The term “manipulation” with reference to a database refers to a variety of processing operations associated with data points included in the database. Examples of processing operations include selecting, sorting, sifting, aggregating, clustering, modeling, exploring, and segmenting data points using various data attributes associated with the data points. In some instances, the terms “aggregation” and “clustering” with reference to a database can refer to grouping data points based on one or more data attributes (e.g., one or more common data attributes). Conversely, the term “segmentation” with reference to a database can refer to partitioning data points into discrete clusters or groups based on one or more data attributes. Available systems for creating databases and manipulating the resulting databases include, for example, Sybase® (Sybase Systems, Emeryville, Calif.), Oracle® (Oracle Inc., Redwood Shores, Calif.), and Sagent Design Studio® (Sagent Technologies Inc., Mountain View, Calif.) systems software. Furthermore, statistical packages and systems for data analysis and data mining are also available. Illustrative examples include SAS® (SAS Institute Inc., Cary, N.C.) and SPSS® (SPSS Inc., Chicago, Ill.) systems software.

The term “data mining” refers to a variety of processing operations (e.g., selecting, exploring, modeling, and so forth) to identify trends, patterns, or other relationships within and among various data points and data attributes.

### Gene Expression Data

Gene expression data can be obtained using various methods. For example, gene expression data can be obtained using gel-based methods; sequencing-based methods such as using expressed sequence tag (“EST”) databases (See e.g., Adams et al. (1993) Nature Genetics 4: 373) and serial analysis of gene expression (“SAGE”) databases (See e.g., Velculescu et al. (1995) Science 270: 484); PCR-based methods such as differential display (See e.g., Liang et al. (1992) Cancer Res. 52: 6966; and Liang and Pardee (1992) Science 257: 967); methods based on hybridization to microarrays of EST clones or polynucleotides (See e.g., Chee et al. (1996) Science 274: 610; DeRisi et al. (1996) Nat. Genet. 14: 457; Maskos and Southern (1993) Nucleic Acids Res. 21: 4663; and Schena et al. (1996) Proc. Natl. Acad. Sci. 93: 10614); and methods based on subtractive hybridization (See e.g., Diatchenko et al. (1996) Proc. Natl. Acad. Sci. 6025). In some instances, microarrays are used to hybridize target polynucleotides with probes immobilized on a support to detect gene expression levels. The gene expression levels are then analyzed using the methods described herein to identify relationships between genes. Gene expression levels can be weighted or scaled to normalize data and can be expressed as an absolute increase or decrease in gene expression levels, a relative change in gene expression levels (e.g., a percentage change), the degree of change relative to control, threshold, or baseline gene expression levels, and the like.

Because various cell nuclei of an organism typically carry the same genes, differences in protein products in different cell types can be the result of selective gene expression. Typically, a first level of regulation of gene expression is at the level of transcription, namely, by varying the frequency with which a gene is transcribed into nascent pre-mRNA by a RNA polymerase. Regulation of transcription can be an important step in controlling gene expression because transcription can constitute an input of an mRNA pool. Transcriptional regulation can be achieved through various methods. For example, transcription can be controlled by: (1) cis-acting transcriptional control sequences and transcriptional factors; (2) different gene products from a single transcription unit; (3) epigenetic mechanisms; and (4) long range control of gene expression by chromatin structure. Data points obtained from detection of gene expression under any of these conditions can be used in the methods described herein.

Microarrays (e.g., DNA microarrays) can be used for monitoring gene expression. The fabrication and application of microarrays in gene expression monitoring can be performed as, for example, disclosed in WO 97/10365 and WO 92/10588. In some instances, high-density polynucleotide arrays can be synthesized using methods such as Very Large Scale Immobilized Polymer Synthesis (“VLSIPS”) disclosed in U.S. Pat. No. 5,445,934. Generally, in microarrays, a particular probe occupies a particular location on a substrate. The probe can be a full-length gene or a fragment thereof, an EST or a fragment thereof, or any other polynucleotide. Microarrays can be fabricated by de novo synthesis of probes on a substrate or by spotting or transporting probes onto specific locations on the substrate. Polynucleotides from a sample can be purified and/or isolated from biological samples, such as, for example, a bacterial plasmid containing a cloned segment of a sequence of interest. Sample polynucleotides can also be produced by amplification of templates. For example, PCR and in vitro transcription are suitable nucleic acid amplification methods. Subsequently, polynucleotides of a biological sample can be hybridized with probes immobilized on a microarray, and the amount of target polynucleotides hybridized to each probe in the microarray can be detected as, for example, disclosed in WO 01/42512.

A detection system can be used to measure the absence, presence, and amount of hybridization for various distinct sequences simultaneously, sequentially, or a combination thereof. Detection systems can include, for example, spectroscopic, electrochemical, physical, light scattering, radioactive, and mass spectroscopic detectors. Spectroscopic detection methods can include electronic spectroscopy (e.g., ultraviolet and visible light absorbance, luminescence, and refractive index), vibrational spectroscopy (e.g., IR and Raman), and x-ray spectroscopy. One suitable detection method involves use of a confocal microscope and fluorescent labels. A fluorescence signal produced is typically proportionate to the level of gene expression. Thus, dyes or labeling compounds can be detected on a periodic basis and can be quantified. Typically, duplicate hybridizations are performed. Comparative analysis of the intensity of fluorescent signals originating from different biological samples for a particular location of a microarray can indicate a differential expression of a gene associated with that location. Detection of altered expression of human phospholipid-binding protein (“PLBP”) using fluorescence detection in microarrays can be performed as, for example, disclosed in U.S. Pat. No. 5,888,742 to Lal et al.

### Mutual Information

Embodiments of the invention relate to clustering biological data based on information theory. In accordance with information theory, relatedness of one variable with respect to another variable can be measured based on a representation of the variables' entropies, which representation is referred to as mutual information. In some instances, various gene expression patterns can be compared to identify relationships between genes of a genome. In particular, the methods described herein can be used to compare expression levels of two or more genes gᵢ, gⱼ, . . . , gₘ over n conditions. Each of the n conditions can correspond to a particular measurement or set of measurements of the expression levels of the genes gᵢ, gⱼ, . . . , gₘ. For example, each of the n conditions can correspond to a particular microarray experiment measuring the expression levels of the genes gᵢ, gⱼ, . . . , gₘ. Various microarray experiments can be carried out with the same biological sample or different biological samples, and with the same experimental condition or different experimental conditions. When performing such comparison with respect to expression patterns of the m genes, mutual information is typically small if expression levels of two or more genes are unrelated. Typically, mutual information approaches 0 as the degree of independence of gene expression levels increases and approaches 1 as the degree of dependence of gene expression levels increases. Thus, mutual information can be used as a metric that indicates the degree of similarity of two gene expression patterns. Once derived, mutual information can be used in conjunction with a clustering technique (e.g., a conventional clustering technique) to identify clusters of similar gene expression patterns.

Unlike other metrics used in existing clustering methods, mutual information can take into account the magnitude of gene expression that is measured. Advantageously, systemic differences between gene expression levels, which can impede use of linear correlation coefficients, can actually strengthen relationships identified using mutual information. This is because mutual information can effectively handle outliers where gene expression levels are substantially removed from a typical value (e.g., an average or mean value). Also, unlike a Pearson correlation coefficient metric, mutual information can be used to determine negative and non-linear correlations as well as positive and linear correlations. Thus, mutual information can be used to cluster genes that exhibit different kinetics for a particular condition. For example, under certain conditions, genes gᵢ and gⱼ may be correlated with gene gₘ, but gene gᵢ may respond by increasing its expression level, while gene gⱼ may respond by decreasing its expression level. Such relationships between the genes can be identified using mutual information as a metric.

For some embodiments of the invention, a mutual information M can be derived as a matrix according to equation 1:

$$M ( {X}_{i} , {X}_{j} ) = {\sum }_{x = 0 , 1} {\sum }_{y = 0 , 1} {P}_{ij , xy} \times {log}_{2} \frac{{P}_{ij , xy}}{{P}_{ix} \times {P}_{jy}} , \qquad ( equation 1 )$$

where variable Xᵢ represents a first biological quantity of interest (e.g., expression level of gene gᵢ), variable Xⱼ represents a second biological quantity of interest (e.g., expression level of gene gⱼ), x represents a particular state associated with the first biological quantity (e.g., expression state for gene gᵢ being repressed (“0”) or induced (“1”)), and y represents a particular state associated with the second biological quantity (e.g., expression state for gene gⱼ being repressed (“0”) or induced (“1”)). Referring to equation 1, Pᵢₓ represents a probability of the first biological quantity being in state x over n conditions, P_{jy} represents a probability of the second biological quantity being in state y over the n conditions, and P_{ij,xy} represents a joint probability of the first biological quantity being in state x and the second biological quantity being in state y over the n conditions. While a logarithm with base 2 is shown in equation 1, it is contemplated that a logarithm with a different base can be used, such as, for example, a logarithm with base 10 or a natural logarithm.

When applied to gene expression data, the methods described herein can be used to calculate probabilities of a gene being in an induced expression state and being in a repressed expression state. Mutual information can be calculated by summing over various possible expression states of two genes. A high value of the mutual information for the two genes can be indicative of a biological relationship between the genes. For example, a zero value of the mutual information can indicate that a joint distribution of expression levels holds no more information than when considering the genes separately. A higher value of the mutual information can indicate that one gene is non-randomly associated with the other gene. In this manner, mutual information can be used as a metric for the two genes to measure their degree of inter-dependence.

Gene expression is typically a continuous phenomenon. As a result, partitioning a continuum of gene expression levels into bins can lead to errors and loss of information. According to the methods described herein, gene expression levels can be represented by a probability function. Typically, a probability function is continuous and monotonic. In some instances, gene expression levels can be represented using a sigmoidal probability function according to equation 2.

pᵢₖ=g_{μ}_{ᵢ}(eᵢₖ−θᵢ), (equation 2)

where k=1,2, . . . n and represents a particular condition, eᵢₖ represents an expression level of gene gᵢ under condition k, and g_{μ}(x)=1/(1+e^{-μx}). An expression level of gene gⱼ can be similarly represented using equation 2 with i set to j. Each gene can be associated with two parameters (e.g., μᵢ and θᵢ) that are specific to the gene. The parameters μᵢ and θᵢ can represent adjustable parameters for gene gᵢ. Referring to equation 2, pᵢₖ represents a probability of gene gᵢ under condition k being in an induced expression state. In some instances, pᵢₖ can be interpreted as a probability that the expression level eᵢₖ of gene gᵢ under condition k is associated with a binary value of 1. A probability qᵢₖ of gene gᵢ under condition k being in a repressed expression state can be obtained by subtracting pᵢₖ from 1. In some instances, qᵢₖ can be interpreted as a probability that the expression level eᵢₖ of gene gᵢ under condition k is associated with a binary value of 0.

Advantages of using a probability function as shown in equation 2 can be understood with the following example. Assuming that the gene-specific parameter θᵢ has a value of 0 and using a discrete representation, expression levels of 0.1 and 3.5 of gene gᵢ would normally be converted to the same value associated with an induced expression state (e.g., 1), whereas expression level of −0.05 would normally be converted to a value associated with a repressed expression state (e.g., 0). However, the real change in expression level between a value of 0.1 and −0.05 can be fairly small. Such information can be lost when gene expression levels are binned into discrete bins for purposes of calculating mutual information.

In some instances, gene expression levels can be represented using a probability function according to equation 3:

pᵢₖ=rᵢₖ^{μ}^{ᵢ}/(rᵢₖ^{μ}^{ᵢ}+cᵢₖ^{μ}^{ᵢ}e^{θ}^{ᵢ}^{μ}^{ᵢ}), (equation 3)

where rᵢₖ represents a “raw” expression level of gene gᵢ under condition k, and cᵢₖ represents a control expression level of gene gᵢ under condition k. Equation 3 can be derived from equation 2 under the assumption that eᵢₖ=logₑ(rᵢₖ/cᵢₖ). Similarly, an expression level of gene gⱼ can be represented using equation 3 with i set to j. Referring to equation 3, when μᵢ and θᵢ are set to 1 and 0.0, respectively, it follows that:

pᵢₖ=rᵢₖ/(rᵢₖ+cᵢₖ). (equation 4)

Thus, “raw” gene expression data from microarray experiments can be used to calculate the probability pᵢₖ in accordance with equation 3 or 4. In microarray experiments using, for example, a two dye system of red and green fluorescent labels, rᵢₖ can correspond to measured red fluorescence due to hybridization of target polynucleotides to a probe associated with a gene under investigation, and cᵢₖ can correspond to measured green fluorescence due to hybridization of control polynucleotides to the probe. Upon completion of hybridization, the microarray can be read, and fluorescence intensity data can be used in equation 3 or 4 to calculate pᵢₖ.

A 2×2 contingency table or matrix T_{ij,xy} for genes gᵢ and gⱼ can be derived as follows:

$${T}_{ij , xy} = \begin{matrix}0 \\ \\ 1\end{matrix} {( \begin{matrix}{\sum }_{k = 1}^{n} {q}_{ik} {q}_{jk} & {\sum }_{k = 1}^{n} {q}_{ik} {p}_{jk} \\ {\sum }_{k = 1}^{n} {p}_{ik} {q}_{jk} & {\sum }_{k = 1}^{n} {p}_{ik} {p}_{jk}\end{matrix} )}^{\begin{matrix}\begin{matrix}0 & & & 1\end{matrix} & \end{matrix}} . \qquad ( equation 5 )$$

Mutual information for genes gᵢ and gⱼ can then be calculated according to equation 1, where

$${P}_{ij , xy} = {T}_{ij , xy} / n \\ {P}_{ix} = {\sum }_{y = 0 , 1} {T}_{ij , xy} / n \\ {P}_{jy} = {\sum }_{x = 0 , 1} {T}_{ij , xy} / n , \qquad ( equation 6 )$$

where subscripts j and i may be implicit for Pᵢₓ and p_{jy} respectively. Since the contingency table T_{ij,xy} is derived from a probability function, the magnitude of change in gene expression levels from gene-specific parameters θᵢ and θⱼ can be accounted for. Given that pᵢₖ+qᵢₖ)−(pⱼₖ+qⱼₖ) is equal to 1, various elements of P_{ij,xy} for different pairs (x, y) contribute 1 to P_{ij,xy} which elements are distributed fractionally with respect to the four cells of P_{ij,xy}.

As μᵢ→∞ in equation 2, gene expression levels can be converted into a binary representation (e.g., 0 or 1). Thus, in some instances, mutual information can be calculated for a discrete representation of gene expression levels. For example, measured gene expression levels for each gene can be quantized into q bins, where q can have a value between 2 and ∞. Mutual information can be calculated using a q×q contingency table. In one case, gene expression levels can be quantized into two bins, such as, for example, bins with binary values of 0 and 1. For condition k and genes gᵢ and gⱼ, gene-specific parameters θᵢ and θⱼ can be set. For gene gᵢ, if its expression level eᵢₖ for condition k is greater than or equal to the gene-specific parameter θᵢ, a binary representation of its expression level bᵢₖ is given a value of 1. If its expression level is less than the gene-specific parameter θᵢ, then bᵢₖ is given a value of 0. For gene gⱼ, bⱼₖ can be similarly obtained. In accordance with such binary representation, a 2×2 contingency table or matrix T_{ij,xy} for genes gᵢ and gⱼ can be derived as follows:

$${T}_{ij , xy} = \begin{matrix}0 \\ 1\end{matrix} {( \begin{matrix}\# k : {b}_{ik} = 0 ; {b}_{jk} = 0 & \# k : {b}_{ik} = 0 ; {b}_{jk} = 1 \\ \# k : {b}_{ik} = 1 ; {b}_{jk} = 0 & \# k : {b}_{ik} = 1 ; {b}_{jk} = 1\end{matrix} )}^{\begin{matrix}\begin{matrix}0 & & & & & & & & & 1\end{matrix} & \end{matrix}} . \qquad ( equation 7 )$$

where the notation “#k: bᵢₖ=a; bⱼₖ=b” represents the number of conditions of the n conditions for which bᵢₖ has the value a and bⱼₖ has the value b. Mutual information for genes gᵢ and gⱼ can then be calculated according to equations 1 and 6.

Some embodiments of the invention relate to clustering selected gene expression data using mutual information as a metric. Clustering results can be displayed in the form of, for example, various lists of genes associated with different clusters. For example, for a database including gene expression data for a set of genes of a genome, a set of data records including various data points can be selected for clustering. The data records can be selected by user-defined criteria. The criteria can specify, for example, genes that are up-regulated under a particular condition, genes that are down-regulated under a particular condition, genes associated with a disease, single nucleotide polymorphisms within a gene and their response under a particular condition, and the like. Probabilities for a first set of data records, a second set of data records, a third set of data records, and an m^{th} set of data records can be calculated using the equations set forth above. The probabilities can then be used to calculate mutual information between various data records of the m sets of data records. Thus, embodiments of the invention can provide a method wherein an entire database can be clustered, a part of the database can be clustered, or selected data records of the database can be clustered.

### Database

One method of forming a database according to an embodiment of the invention includes: (1) collecting acquired data points, wherein the acquired data points can include information obtained from, for example, microarray experiments for determining gene expression; and (2) associating the acquired data points with relevant data attributes. The method may further include: (3) determining derived data points from one or more acquired data points; and (4) associating the derived data points with relevant data attributes.

Thus, methods for analyzing gene expression data can begin with the collection of data points associated with measurement values, such as, for example, measurements of fluorescence intensities from hybridization experiments performed on microarrays. Data records can be formulated in a spreadsheet-like format, such as, for example, by including data attributes such as sequence identification number, source of tissue, date of library formation, patient age, sex, weight, current medications, geographic location, and so forth. A database may further include derived data points from one or more acquired data points. Thus, for example, the database may include calculated mutual information and clustering information for various genes. Measurement values and derived data points are collected and calculated and may be associated with one or more data attributes to form the database.

A number of formats can be used for storing data points and associating the data points with data attributes, including, for example, tabular, relational, and dimensional (e.g., multi-dimensional). Databases can include various data points, and each data point can include a numeric value associated with a physical measurement (e.g., an “acquired” datum or data point) or a numeric value derived using the various methods disclosed herein. Databases can include “raw” data and can also include additional related information, such as, for example, data attributes or tags. Databases can take a number of different forms and can be structured in a variety of ways.

A typical format is tabular, which is sometimes referred to as a spreadsheet format. A variety of spreadsheet programs can be employed, including, for example, Microsoft Excel spreadsheet software and Corel Quattro spreadsheet software. In this format, association of data points with related data attributes typically occurs by entering a data point and/or data attributes related to that data point in a particular row at or subsequent to the time a measurement occurs.

Furthermore, relational database systems and management (See, e.g., Database Design for Mere Mortals, by Michael J. Hernandez, 1997, Addison-Wesley Pub. Co., publisher; Database Design for Smarties, by Robert J. Muller, 1999, Morgan Kaufmann Publishers, publisher; Relational Database Design Clearly Explained, by Jan L. Harrington, 1998, Morgan Kaufmann Publishers, publisher) and dimensional database systems and management (See, e.g., Data-Parallel Computing, by V. B. Muchnick, et al., 1996, International Thomson Publishing, publisher; Understanding Fourth Dimensions, by David Graves, 1993, Computerized Pricing Systems, publisher) may be employed as well.

Relational databases typically support a set of operations (e.g., select, join, and combine) defined by relational algebra governing relations within the databases. Such databases typically include tables composed of columns and rows for data points included in the databases. Each table of a database can include a primary key, which can be any column or set of columns with values that can serve to uniquely identify rows in the table. Tables in a database can also include a foreign key that is a column or set of columns with values that can match primary key values of another table.

Relational databases can be implemented in various ways. For instance, in Sybase® databases (Sybase Systems, Emeryville, Calif.), tables can be separated into different databases. With Oracle® databases (Oracle Inc., Redwood Shores, Calif.), in contrast, various tables are typically not separated, since there is typically one instance of workspace with different ownership specified for different tables. In some instances, databases can be all located in a single database (e.g., a data warehouse) on a single computer. In other instances, various databases are split between different computers.

It should be understood, of course, that databases are not limited to the foregoing arrangements or structures, and a variety of other arrangements can be used.

### Database Manipulation

Databases formulated using the methods described herein can be manipulated, for example, using a variety of statistical analyses to produce useful information. The databases may be generated, for example, from data points collected for an individual or from a group of individuals over a defined period of time (e.g., days, months, or years), from derived data points, and from data attributes. Database manipulations are useful, for example, in correlating progression of a disease with gene expression patterns.

Some embodiments of the invention further relate to a method for manipulating acquired data points, derived data points, and data attributes in a database to provide a useful result. The method can include providing acquired data points, derived data points, and data attributes in a database and manipulating and/or analyzing the database.

For example, data points may be aggregated, sorted, selected, sifted, clustered, and segregated using data attributes associated with the data points. A number of database management systems and data mining software programs may be used to perform the desired manipulations.

In some instances, relationships in a database can be directly queried. Alternatively, or in conjunction, data points can be analyzed by statistical methods to evaluate relationships based on manipulating the database. For example, a distribution curve can be established for selected data points, and a mean, a median, and a mode can be calculated for the distribution. Furthermore, data spread characteristics (e.g., variability, quartiles, and standard deviations) can be calculated.

Non-parametric tests may be used for testing whether variations between empirical data and experimental expectancies are attributable merely to chance or to a set of variables being examined. These tests include, for example, Chi Square test, Chi Square Goodness of Fit, 2×2 Contingency Table, Sign Test, and Phi Correlation Coefficient.

Tools and analyses implemented in conventional data mining software can be applied for analysis of databases. Such tools and analyses include, for example, cluster analysis, factor analysis, decision trees, neural networks, rule induction, data driven modeling, and data visualization. Some data mining techniques can be used to discover relationships that are more empirical and data-driven rather than theory-driven.

Examples of data mining software that can be used for analysis and/or generation of databases include Link Analysis (e.g., Associations. Analysis, Sequential Patterns, Sequential Time Patterns, and Bayes Networks); Classification (e.g., Neural Networks Classification, Bayesian Classification, K-nearest Neighbors Classification, Linear Discriminant Analysis, Memory-based Reasoning, and Classification by Associations); Clustering (e.g., K-Means Clustering, Demographic Clustering, Relational Analysis, and Neural Networks Clustering); Statistical methods (e.g., Means, Standard deviation, Frequencies, Linear Regression, Non-linear Regression, T-tests, F-tests, Chi2-tests, Principal Component Analysis, and Factor Analysis); Prediction (e.g., Neural Networks Prediction Models, Radial Based Functions predictions, Fuzzy logic predictions, Times Series Analysis, and Memory-based Reasoning); Operating Systems; and others (e.g., Parallel Scalability, Simple Query Language functions, and C++ objects generated for applications). Companies that provide such software include, for example, Adaptative Methods Group at UTS (UTS City Campus, Sydney, NSW 2000), CSI®, Inc., (Computer Science Innovations, Inc. Melbourne, Fla.), IBM® (International Business Machines Corporation, Armonk, N.Y.), Oracle® (Oracle Inc., Redwood Shores, Calif.), SAS® (SAS Institute Inc., Cary, N.C.), and SPSS® (SPSS Inc., Chicago, Ill.).

These statistical analyses may be applied to databases formulated using the methods described herein, such as, for example, databases including fluorescence intensities, calculated mutual information, and data attributes.

### Hardware/Software and Computer System Considerations

A. Hardware/Software

Various computer systems, typically including one or more computers, can be used to store, retrieve, and analyze information according to the methods described herein. A computer system can be as simple as a stand-alone computer having a form of data storage, such as, for example, a disk drive, a removable disk storage such as a ZIPS drive (Iomega Corporation, Roy, Utah), an optical medium (e.g., a CD-ROM), a magnetic tape, a solid-state memory, a bubble memory, or a combination thereof.

Alternatively, the computer system can include a network including two or more computers linked together via, for example, a network server. The network can include an Intranet, an Internet connection, or both. Thus, the computer system can include an Internet-based system or a non-Internet based system. In some instances, computer systems are provided with processors and software for receiving and storing gene expression data or any other biological data in a database and for executing operations on the stored data. The computer systems can be linked to databases such as Genbank and DrugMatrix (Iconix Pharmaceuticals, Inc., Mountain View, Calif.).

In addition, devices such as Personal Digital Assistants (“PDAs”), such as, for example, Palm Pilot™ (Palm Inc., Santa Clara, Calif.) or Handspring™ Visor™ (Handspring, Inc., Mountain View, Calif.), and Pocket PCs (“PPCs”), such as, for example, Casio® EM500 Multimedia Cassiopeia Pocket PC (Casio Inc., Dover, N.J.) or Compaq® iPAQ™ (Compaq Computer Corporation, Houston, Tex.), can be used to store and retrieve database information. The PDAs or PPCs can be simple stand-alone devices that are not networked to other computers and can be provided with a form of data storage, such as, for example, a solid-state memory, a secure digital (“SD”) card, or a multimedia card (“MMC”). Alternatively, or in conjunction, the PDAs or PPCs can be linked to a network in which the devices are linked to one or more computers, such as, for example, a network server or a PC. The networked PDAs or PPCs can be linked to a network that can include an Intranet, an Internet connection, or both. Thus, the PDAs or PPCs can be included in an Internet attached system or a non-Internet attached system.

For example, mutual information regarding gene expression data and parameters used to acquire fluorescence intensities (e.g., acquisition parameters) can be transmitted with a microarray image over a local or long-distance network. The acquisition parameters can be transmitted before, simultaneously with, or after the image is transmitted over the network. These parameters can be entered manually into a data registration sheet or database that can be transmitted before, simultaneously with, or after the above-mentioned data. In some instances, at least some of these parameters can be transmitted automatically, while others can be stored either at a local site or at another site of the network.

Various types of computer software can be installed in a PC, a Silicon Graphics, Inc. (“SGI”) computer, a Macintosh computer, or the like.

B. Stand-alone Computer System

In some instances, a computer system includes a computer having an Intel® Pentium® microprocessor (Intel Corporation, Santa Clara, Calif.) that runs the Microsoft® WINDOWS® Version 3.1, WINDOWS95®, WINDOWS98®, WINDOWS2000®, WINDOWSNT®, or WINDOWSXP® operating system (Microsoft Corporation, Redmond, Wash.). Computers including other microprocessors such as an ATHLON™ microprocessor (Advanced Micro Devices, Inc., Sunnyvale, Calif.) and an Intel® CELERON® and XEON® microprocessors can be utilized. Computer systems can also include other operating systems, such as, for example, UNIX, LINUX, Apple MAC OS 9 and OS X (Apple, Cupertino, Calif.), PalmOS® (Palm Inc., Santa Clara, Calif.), Windows® CE 2.0, or Windows® CE Professional (Microsoft Corporation, Redmond, Wash.). Also, a computer system typically includes a data storage for storing and retrieving database information.

Communication with a computer system can be achieved using a standard computer interface, such as, for example, a serial interface or Universal Serial Bus (“USB”) port. Standard wireless interfaces, such as, for example, using radio frequency (“RF”) technologies (e.g., IEEE 802.11 and Bluetooth) and infrared technologies, can also be used. Data can be encoded in a conventional manner, such as, for example, using American Standard Code for Information Interchange (“ASCII”) format. The ASCII format refers to a standard seven-bit code that was proposed by ANSI in 1963 and finalized in 1968.

A computer system can store information into a database using a wide variety of computer software for inputting data points and associating the data points with data attributes. Available computer software for generating databases and manipulating the resulting databases include, for example, Excel® spreadsheet software (Microsoft® Corporation, Seattle, Wash.), Quattro® spreadsheet software (Corel Inc., Ottawa, Canada), Sybase® software (Sybase Systems, Emeryville, Calif.), Oracle® software (Oracle Inc., Redwood Shores, Calif.), and Sagent Design Studio® systems software (Sagent Technologies Inc., Mountain View, Calif.). Furthermore, statistical packages and systems for data analysis and data mining can also be used as discussed previously. The database can be stored using, for example, a disk drive (e.g., internal or external to the computer system), a Read/Write CD-ROM drive, a Read/Write DVD-ROM drive, a tape storage system, a solid-state memory, a bubble memory, a SD card, or a MMC. In addition to storage in the database, information can be forwarded to an auxiliary readout device such as a display monitor.

C. Networked Computer System

Connection to a network can be made directly or via a serial interface adapter. For example, a direct connection could be made if a readout device has wireless capability. Alternately, a connection can be made through a serial interface adapter or a docking station linking the device and the network.

In some instances, networked computer systems are suitable for performing the methods described herein. A number of networks can be used, such as, for example, a local area network (“LAN”) or a wide area network (“WAN”). A network typically includes functionality for forwarding data in established formats, such as, for example, Ethernet format, Token Ring Packets or Frames, HTML format, or WAN digital or analog formats. For certain applications, data is forwarded in conjunction with additional information, such as, for example, a Destination Address or Cyclic Redundancy Check (“CRC”). A CRC technique can be implemented to verify data reliability and to detect errors in data communications. In particular, the CRC technique can be used to protect blocks of data called frames. Using this technique, a transmitter can append an extra n-bit sequence to a frame called a Frame Check Sequence (“FCS”). The FCS holds information (e.g., redundant information) about the frame that allows errors in the frame to be detected. The CRC technique can be used in connection with data transmitted in a particular format across a transmission line for delivery to a database server. Furthermore, networked computer systems can include computer software and hardware to receive data from a readout device, store the data, process the data, display the data in a variety of ways, communicate the data back to the readout device, as well as allow communication among a variety of users and between these users and the readout device.

A network, such as, for example, an Ethernet, Token Ring, or FDDI network, can be accessed using a standard network interface card (“NIC”), such as, for example, a 3Com® EtherLink® NIC (3Com, Inc, Santa Clara, Calif.) that can provide network connections over UTP, coaxial, or fiber-optic cabling, or an Intel® PRO/100 S Desktop Adapter (Intel Corporation, Santa Clara, Calif.). A network can also be accessed using standard remote access technology, such as, for example, a modem using a telephone system (“POTS”) line, a xDSL router connected to a digital subscriber line (“DSL”), or a cable modem. Additionally, a network can be connected to a LAN using a standard wireless interface, such as, for example, using RF technologies.

A networked computer system can have a similar capability for storing and retrieving data as a stand-alone computer system. In some instances, the networked computer system can transfer data to any device connected to or included in the networked computer system. For example, data can be transferred to a medical doctor or a medical care facility using standard e-mail software or to a central database (e.g., a data warehouse of acquired data points, derived data points, and data attributes obtained from a large number of subjects) using database query and update computer software. For certain applications, a user can access desired data using any computer system with Internet access.

A networked computer system can include a World Wide Web application, which can include executable code required to generate database language statements, such as, for example, SQL statements or embedded SQL statements. The application can further include a configuration file that includes pointers and addresses to various computer software entities that are located in a database server. In addition, different external and internal databases can be accessed in response to a user request. The configuration file can also direct requests for database server resources to an appropriate hardware. Such requests may be desirable if the database server is distributed over two or more different computers.

Typically, a networked computer system includes a World Wide Web browser that can provide a user interface to a database server. The networked computer system can construct search requests for retrieving information from a database via the browser. A browser typically allows users to point and click to user interface elements, such as, for example, buttons, pull down menus, and other graphical user interface elements to prepare and submit a search query that extracts relevant information from a database. Search requests formulated in this manner can be subsequently transmitted to a World Wide Web application, which formats the search requests to produce a search query that can be used to extract relevant information from the database.

Web-based applications typically access data from a database by constructing a search query in a database language (e.g., Sybase or Oracle SQL), which is then transferred to a relational database management system that in turn processes the search query to obtain relevant information from the database.

Accordingly, some embodiments of the invention relate to methods of providing microarray images, gene expression data, calculated mutual information, and results of clustering using mutual information on a network (e.g., the Internet). Some embodiments of the invention also relate to methods of using a connection to a network to provide real-time or delayed data analysis. Appropriate network security features (e.g., for data transfer, inquiries, device updates, and so forth) can be employed. Furthermore, a remote computer can be used to analyze microarray data that has been transmitted over a network automatically or in response to user inputs.

It should be recognized that the embodiments discussed above are provided by way of example, and various other embodiments are contemplated. For example, while certain embodiments have been described in connection with clustering gene expression data, it should be recognized that the methods described herein can be applied to any biological data. Thus, referring to equation 1, the variables Xᵢ and Xⱼ can represent any two biological quantities of interest, and the methods described herein can be applied to identify a relationship between the two biological quantities. For some embodiments of the invention, the variables Xᵢ and Xⱼ can represent clinical observables, such as, for example, blood pressure, body temperature, blood or urine glucose levels, cholesterol levels (e.g., HDL and LDL levels), viral load levels, blood hematocrit levels, white cell count, tumor size, or any other biological quantity associated with a patient's biochemical or physiological state.

Also, while certain embodiments have been described in connection with deriving mutual information for two variables Xᵢ and Xⱼ, it should be recognized that the methods described herein can also be applied to derive mutual information for three or more variables Xᵢ, Xⱼ, . . . Xₘ. In addition, while certain embodiments have been described in connection with deriving mutual information for variables having two states, it should be recognized that the methods described herein can also be applied to derive mutual information for variables having three or more states. Thus, for example, each gene can have q expression states, where q can have any value between 2 and ∞, and mutual information can be calculated using a q×q contingency table. The q expression states can correspond to, for example, a highly induced state, a moderately induced state, a non-modulated state, a moderately repressed state, and a highly repressed state.

As another example, relationships identified by analyzing gene expression data can be used to identify, for example, a regulatory function of a particular gene. Thus, some embodiments of the invention relate to methods for detecting a regulatory function of a target gene by identifying whether the target gene regulates expression of other genes. In some instances, a target gene is mutated, or its functions can be repressed by various methods. A variety of methods can be used to specifically repress expression of a target gene, including, for example, using antisense polynucleotides and antisense genes. For example, in one type of experiment, expression of a gene of interest can be suppressed by exposing a biological sample to antisense polynucleotides. Expression of various genes is monitored to provide a gene expression pattern. Expression of the gene of interest is then restored, and expression of the various genes is similarly monitored to provide another gene expression pattern. By comparing the two gene expression patterns using the methods described herein, the regulatory function of the gene of interest can be deduced. In other embodiments, a target gene is introduced to a biological sample (e.g., a cell) that lacks expression of the target gene, and expression of various genes is monitored to detect any alteration of a gene expression pattern (See e.g., U.S. Pat. No. 6,322,973 to Bostian et al.). Cell lines can be advantageous for studying regulatory function of a target gene because of low cost of maintenance and construction. In yet other embodiments, a target gene can be substantially or completely suppressed for a certain period of time to thereby use up associated gene products. Expression of various genes, such as, for example, more than 10 genes, more than 100 genes, or more than 1000 genes, can be monitored to detect changes in gene expression pattern. Changes in expression can be analyzed using mutual information as described herein to identify specific genes that are potentially regulated by a target gene.

Some embodiments of the invention relate to identifying the function of a mutation in a regulatory gene by monitoring gene expression. For example, polynucleotide from a wild-type biological sample and from a mutant biological sample can be analyzed to obtain wild-type and mutant expression patterns of various genes. The gene expression patterns may be used to calculate a mutual information, and clustering may be performed using the mutual information as a metric.

Some embodiments of the invention relate to methods, compositions, and apparatus for studying normal and abnormal functions of genes. The information obtained using the methods described herein can be used for drug discovery. For example, if a target gene is found to be associated with a particular disease, a list of potential up-stream regulatory genes can be found by analyzing gene expression data using the methods described herein. Research efforts can then be concentrated on the potential up-stream genes as drug targets. Similarly, if a gene mutation causes a disease, it may affect genes that are both related and unrelated to the pathogenesis of the disease. The relationships between the gene mutation and various genes can be explored to find pathogenic genes. In some embodiments, a relationship between a disease and expression of various genes is determined, and genes whose expression is altered in a diseased tissue are identified. Up-stream genes that regulate the altered genes are indicated as functionally altered or potentially mutated.

For some embodiments of the invention, it is desirable to monitor the effect of a stimulus or a set of stimuli on gene expression. For example, a set of biological samples can be exposed to various compounds (e.g., compounds A, B, and C) under the same experimental condition or different experimental conditions. The compounds can include, for example, drugs or drug candidates. Based on exposure to the compounds, gene expression data can be obtained. The gene expression data can indicate genomic responses to the compounds. In such embodiments, a set of gene expression levels for various genes can be obtained for compound A by monitoring the effect of compound A on the set of biological samples. Likewise, a set of gene expression levels for the various genes can be obtained for compound B, and a set of gene expression levels for the various genes can be obtained for compound C. The sets of gene expression levels can then be clustered with respect to the compounds using mutual information. In particular, clustering can be performed using compound as a query variable and gene expressions as data records. Clustering results can thus identify compounds that have similar biological activity or mode of action, compounds that have similar or different specificities, and the like. In some instances, by comparing a gene expression pattern obtained by administration of a new compound with a gene expression pattern obtained by administration of a known compound, differences in biological activities of the two compounds can be identified. The differences in the biological activities can be identified based on, for example, identifying genes responsible for the biological activities, determining whether the two compounds have similar or equivalent genomic responses, determining side effects or toxicities of the new compound, and the like.

For still other embodiments, gene expression levels for various genes can be obtained for conditions associated with one or more diseases and for one or more drug therapies and then clustered with respect to the conditions. In a similar manner, various clinical observables can be obtained for the conditions and then clustered with respect to the conditions. Clustering results can provide information regarding effectiveness of a drug and can be used to follow progress of a treatment using the drug.

Some embodiments of the invention relate to a computer storage product including a computer-readable medium having computer-executable code thereon for performing various computer-implemented operations. The term “computer-readable medium” is used herein to include any medium that is capable of storing or encoding a sequence of instructions or codes for performing the methods described herein. The media and code may be those specially designed and constructed for the purposes of the invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; carrier waves signals; and hardware devices that are specially configured to store and execute program code, such as application-specific integrated circuits (“ASICs”), programmable logic devices (“PLDs”), read only memories (“ROMs”), random access memories (“RAMs”), erasable programmable read only memories (“EPROMs”), and electrically erasable programmable read only memories (“EEPROMs”). Examples of computer-executable code include machine code, such as produced by a compiler, and files containing higher-level code that are executed by a computer using an interpreter. For example, an embodiment of the invention may be implemented using Java, C++, or other object-oriented programming language and development tools. Additional examples of computer-executable code include encrypted code and compressed code.

Moreover, some embodiments of the invention may be downloaded as a computer program product, where the program may be transferred from a remote computer (e.g., a server) to a requesting computer (e.g., a client) by way of data signals embodied in a carrier wave or other propagation medium via a communication link (e.g., a modem or network connection). Accordingly, as used herein, a carrier wave can be regarded as a computer-readable medium.

Other embodiments of the invention may be implemented in hardwired circuitry in place of, or in combination with, machine-executable software instructions.

### EXAMPLES

The following examples are provided as a guide for a practitioner of ordinary skill in the art. The examples should not be construed as limiting the invention, as the examples merely provide specific methodology useful in understanding and practicing some embodiments of the invention.

### Example 1

### Mutual Information for Discrete Gene Expression Levels

This example provides a calculation of mutual information for genes gᵢ and gⱼ using a discrete representation of gene expression levels. For n=2, let:

eᵢ=(0.4, −0.2) and eⱼ=(0.3, −0.1).

For bᵢₖ=0 or 1 and bⱼₖ=0 or 1, it follows that:

bᵢ=(1, 0) and bⱼ=(1, 0).

A contingency table can be derived as:

$${T}_{ij} = \begin{matrix}0 \\ 1\end{matrix} {( \begin{matrix}1 & 0 \\ 0 & 1\end{matrix} )}^{\begin{matrix}\begin{matrix} 0 & 1\end{matrix} & \end{matrix}} ,$$

and probabilities can be derived as:

$${P}_{i} = {P}_{j} = \begin{matrix}0 \\ 1\end{matrix} ( \begin{matrix}1 / 2 \\ 1 / 2\end{matrix} )$$

$${P}_{i} \times {P}_{j} = \begin{matrix}0 \\ 1\end{matrix} {( \begin{matrix}1 / 4 & 1 / 4 \\ 1 / 4 & 1 / 4\end{matrix} )}^{\begin{matrix}\begin{matrix} 0 & & 1\end{matrix} & \end{matrix}}$$

$${P}_{ij} \times 1 / 2 {T}_{ij} = \begin{matrix}0 \\ 1\end{matrix} {( \begin{matrix}1 / 2 & 0 \\ 0 & 1 / 2\end{matrix} )}^{\begin{matrix}\begin{matrix} 0 & & 1\end{matrix} & \end{matrix}}$$

Since Pᵢⱼ is substantially different from Pᵢ×Pⱼ, the mutual information calculated using equation (1) is 1, which indicates that there is high dependence between genes gᵢ and gⱼ.

### Example 2

### Mutual Information for Discrete Gene Expression Levels

This example provides another calculation of mutual information for genes gᵢ and gⱼ using a discrete representation of gene expression levels. For n=5, let:

eᵢ=(0.4, −0.2, 0.3, 0.6, −0.5) and eⱼ=(0.3, −0.1, 0.5, 0.2, −0.4).

For bᵢₖ=0 or 1 and bⱼₖ=0 or 1, it follows that:

bᵢ=(1, 0, 1, 1, 0) and bⱼ=(1, 0, 1, 1, 0).

A contingency table can be derived as:

$${T}_{ij} = \begin{matrix}0 \\ 1\end{matrix} {( \begin{matrix}2 & 0 \\ 0 & 3\end{matrix} )}^{\begin{matrix}\begin{matrix} 0 & 1\end{matrix} & \end{matrix}} ,$$

and probabilities can be derived as:

$${P}_{i} = {P}_{j} = \begin{matrix}0 \\ 1\end{matrix} ( \begin{matrix}2 / 5 \\ 3 / 5\end{matrix} )$$

$${P}_{i} \times {P}_{j} = \begin{matrix}0 \\ 1\end{matrix} {( \begin{matrix}4 / 25 & 6 / 25 \\ 6 / 25 & 9 / 25\end{matrix} )}^{\begin{matrix}\begin{matrix} 0 & & 1\end{matrix} & \end{matrix}}$$

$${P}_{ij} \times 1 / 5 {T}_{ij} = \begin{matrix}0 \\ 1\end{matrix} {( \begin{matrix}2 / 5 & 0 \\ 0 & 3 / 5\end{matrix} )}^{\begin{matrix}\begin{matrix} 0 & & 1\end{matrix} & \end{matrix}}$$

Since Pᵢⱼ is substantially different from P_{i.}×Pⱼ, the mutual information calculated using equation (1) is close to 1, which indicates that there is high dependence between genes gᵢ and gⱼ.

### Example 3

### Mutual Information for Continuous Gene Expression Levels

This example provides a calculation of mutual information for genes gᵢ and gⱼ using a probabilistic representation of gene expression levels. For n=2, let:

eᵢ=(0.4, −0.2) and eⱼ=(0.3, −0.1).

Using the sigmoidal probability function given by equation 2 with μᵢ=μⱼ=1 and θᵢ=θⱼ=0, it follows that:

pᵢ=(0.6, 0.45) and pⱼ=(0.57, 0.47).

A contingency table can be derived according to equation 5 as:

$${T}_{ij} = \begin{matrix}0 \\ 1\end{matrix} {( \begin{matrix}0.4 \times 0.43 + 0.55 \times 0.53 & 0.4 \times 0.57 + 0.55 \times 0.47 \\ 0.6 \times 0.43 + 0.45 \times 0.53 & 0.6 \times 0.57 + 0.45 \times 0.47\end{matrix} )}^{\begin{matrix}\begin{matrix}0 & & & & & & & & & 1\end{matrix} & \end{matrix}} = \begin{matrix}0 \\ 1\end{matrix} {( \begin{matrix}0.4635 & 0.4865 \\ 0.4965 & 0.5535\end{matrix} ) ,}^{\begin{matrix}\begin{matrix} 0 & & 1\end{matrix} & \end{matrix}}$$

and probabilities can be derived as:

$${P}_{i} = \begin{matrix}0 \\ 1\end{matrix} ( \begin{matrix}( 0.4635 + 0.4865 ) / 2 \\ ( 0.4965 + 0.5535 ) / 2\end{matrix} ) = \begin{matrix}0 \\ 1\end{matrix} ( \begin{matrix}0.475 \\ 0.525\end{matrix} )$$

$${P}_{j} = \begin{matrix}0 \\ 1\end{matrix} ( \begin{matrix}( 0.4635 + 0.4965 ) / 2 \\ ( 0.4865 + 0.5535 ) / 2\end{matrix} ) = \begin{matrix}0 \\ 1\end{matrix} ( \begin{matrix}0.48 \\ 0.52\end{matrix} )$$

$${P}_{i} \times {P}_{j} = \begin{matrix}0 \\ 1\end{matrix} {( \begin{matrix}0.228 & 0.247 \\ 0.252 & 0.273\end{matrix} )}^{\begin{matrix}\begin{matrix} 0 & & 1\end{matrix} & \end{matrix}}$$

$${P}_{ij} = 1 / 2 {T}_{ij} = \begin{matrix}0 \\ 1\end{matrix} {( \begin{matrix}0.23175 & 0.24325 \\ 0.24825 & 0.27675\end{matrix} )}^{\begin{matrix}\begin{matrix} 0 & & 1\end{matrix} & \end{matrix}}$$

The mutual information can then be calculated according to equation 1.

Each of the patent applications, patents, publications, and other published documents mentioned or referred to in this specification is herein incorporated by reference in its entirety, to the same extent as if each individual patent application, patent, publication, and other published document was specifically and individually indicated to be incorporated by reference.

While the invention has been described with reference to the specific embodiments thereof, it should be understood by those skilled in the art that various changes may be made and equivalents may be substituted without departing from the true spirit and scope of the invention as defined by the claims. In addition, many modifications may be made to adapt a particular situation, material, composition of matter, method, process operation or operations, to the spirit and scope of the invention. All such modifications are intended to be within the scope of the claims. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations is not a limitation of the invention.

What is claimed is:

1. A method of clustering genes, comprising:
for each condition k of n conditions, determining a probability pᵢₖ of a first gene gᵢ being in its induced state and a probability pⱼₖ of a second gene gⱼ being in its induced state;
deriving a contingency table for the first gene gᵢ and the second gene gⱼ based on the probabilities pᵢₖ and pⱼₖ;
deriving a mutual information M for the first gene gᵢ and the second gene gⱼ based on the contingency table; and
clustering the first gene gᵢ and the second gene gⱼ based on the mutual information M as a metric.

2. The method of claim 1, wherein determining the probability pᵢₖ includes calculating the probability pᵢₖ based on a probability function.

3. The method of claim 1, wherein determining the probability pᵢₖ includes calculating the probability pᵢₖ based on:
pᵢₖ=g_{μ}_{ᵢ}(eᵢₖ−θᵢ),
wherein g_{μ}_{ᵢ}(x)=1/(1+e^{-μ}^{ᵢ}^{x}), eᵢₖ represents an expression level of the first gene gᵢ under condition k, and μᵢ and θᵢ represent parameters associated with the first gene gᵢ.

4. The method of claim 1, wherein determining the probability pᵢₖ includes calculating the probability pᵢₖ based on:
pᵢₖ=rᵢₖ^{μ}^{ᵢ}/(rᵢₖ^{μ}^{ᵢ}+cᵢₖ^{μ}^{ᵢ}e^{θ}^{ᵢ}^{μ}^{ᵢ}),
wherein rᵢₖ represents an expression level of the first gene gᵢ under condition k, cᵢₖ represents a control expression level of the first gene gᵢ under condition k, and μᵢ and θᵢ represent parameters associated with the first gene gᵢ.

5. The method of claim 4, wherein μᵢ=1, and θᵢ=0.

6. The method of claim 1, wherein deriving the contingency table includes calculating a 2×2 contingency table T_{ij,xy} based on:
$${T}_{i j , x y} = ( \begin{matrix}{\sum }_{k = 1}^{n} {q}_{i k} {q}_{j k} & {\sum }_{k = 1}^{n} {q}_{i k} {p}_{j k} \\ {\sum }_{k = 1}^{n} {p}_{i k} {q}_{j k} & {\sum }_{k = 1}^{n} {p}_{i k} {p}_{j k}\end{matrix} ) ,$$
wherein qᵢₖ=1−pᵢₖ, qⱼₖ=1−pⱼₖ, x ranges from 0 to 1, and y ranges from 0 to 1.

7. The method of claim 6, wherein deriving the mutual information M includes calculating the mutual information M based on:
$$\begin{matrix}M = {\sum }_{x = 0 , 1} {\sum }_{y = 0 , 1} {P}_{i j , xy} \times {log}_{2} \frac{{P}_{i j , x y}}{{P}_{i x} \times {P}_{j y}} , \\ \begin{matrix}wherein {P}_{i j , xy} = {T}_{i j , xy} / n , {P}_{i x} \\ = {\sum }_{y = 0 , 1} {T}_{i j , xy} / n ,\end{matrix} \\ and {P}_{j y} = {\sum }_{x = 0 , 1} {T}_{i j , xy} / n .\end{matrix}$$

8. A method of clustering genes, comprising:
for each condition k of n conditions, determining a probability pᵢₖ of a first gene gᵢ being in its induced state based on a first probability function and a probability pⱼₖ of a second gene gⱼ being in its induced state based on a second probability function;
deriving a contingency table for the first gene gᵢ and the second gene gⱼ based on the probabilities pᵢₖ and pⱼₖ;
deriving a mutual information M for the first gene gᵢ and the second gene gⱼ based on the contingency table; and
clustering the first gene gᵢ and the second gene gⱼ based on the mutual information M as a metric.

9. The method of claim 8, wherein at least one of the first probability function and the second probability function corresponds to a sigmoidal probability function.

10. The method of claim 8, wherein deriving the contingency table includes calculating a 2×2 contingency table T_{ij,xy} based on:
$${T}_{i j , x y} = ( \begin{matrix}{\sum }_{k = 1}^{n} {q}_{i k} {q}_{j k} & {\sum }_{k = 1}^{n} {q}_{i k} {p}_{j k} \\ {\sum }_{k = 1}^{n} {p}_{i k} {q}_{j k} & {\sum }_{k = 1}^{n} {p}_{i k} {p}_{j k}\end{matrix} ) ,$$
wherein qᵢₖ=1−pᵢₖ, qⱼₖ=1−pⱼₖ, x ranges from 0 to 1, and y ranges from 0 to 1.

11. A method of deriving a mutual information M for a first gene gᵢ and a second gene gⱼ, comprising:
for each condition k of n conditions, determining a probability pᵢₖ of the first gene gᵢ being in its induced state and a probability pⱼₖ of the second gene gⱼ being in its induced state;
deriving a 2×2 contingency table T_{ij,xy} for the first gene gᵢ and the second gene gⱼ based on the probabilities pᵢₖ and pⱼₖ, wherein x ranges from 0 to 1, and y ranges from 0 to 1; and
deriving the mutual information M for the first gene gᵢ and the second gene gⱼ based on the 2×2 contingency table T_{ij,xy}.

12. The method of claim 11, wherein determining the probability pᵢₖ includes calculating the probability pᵢₖ based on:
pᵢₖ=g_{μ}_{ᵢ}(eᵢₖ−θᵢ),
wherein g_{μ}_{ᵢ}(x)=1/(1+e^{-μ}^{ᵢ}^{x}), eᵢₖ represents an expression level of the first gene gᵢ under condition k, and μᵢ and θᵢ represent parameters associated with the first gene gᵢ.

13. The method of claim 11, wherein determining the probability pᵢₖ includes calculating the probability pᵢₖ based on:
pᵢₖ=rᵢₖ^{μ}^{ᵢ}/(rᵢₖ^{μ}^{ᵢ}+cᵢₖ^{μ}^{ᵢ}e^{θ}^{ᵢ}^{μ}^{ᵢ}),
wherein rᵢₖ represents an expression level of the first gene gᵢ under condition k, cᵢₖ represents a control expression level of the first gene gᵢ under condition k, and μᵢ and θᵢ represent parameters associated with the first gene gᵢ.

14. The method of claim 11, wherein deriving the 2×2 contingency table T_{ij,xy} includes calculating the 2×2 contingency table T_{ij,xy} based on:
$${T}_{i j , x y} = ( \begin{matrix}{\sum }_{k = 1}^{n} {q}_{i k} {q}_{j k} & {\sum }_{k = 1}^{n} {q}_{i k} {p}_{j k} \\ {\sum }_{k = 1}^{n} {p}_{i k} {q}_{j k} & {\sum }_{k = 1}^{n} {p}_{i k} {p}_{j k}\end{matrix} ) ,$$
wherein qᵢₖ=1−pᵢₖ, and qⱼₖ=1−pⱼₖ.

15. A method of generating a list of genes, comprising:
providing a set of gene expression data associated with a plurality of genes under n conditions;
selecting a first subset of gene expression data from the set of gene expression data, the first subset of gene expression data being associated with a first gene gᵢ;
selecting a second subset of gene expression data from the set of gene expression data, the second subset of gene expression data being associated with a second gene gⱼ;
for each condition k of the n conditions, determining a probability pᵢₖ of the first gene gᵢ being in its induced state based on the first subset of gene expression data;
for each condition k of the n conditions, determining a probability pⱼₖ of the second gene gⱼ being in its induced state based on the second subset of gene expression data;
deriving a mutual information M for the first gene gᵢ and the second gene gⱼ based on the probabilities pᵢₖ and pⱼₖ; and
based on the mutual information M, generating the list of genes indicating the first gene gᵢ and the second gene gⱼ.

16. The method of claim 15, wherein determining the probability pᵢₖ includes calculating the probability pᵢₖ based on:
pᵢₖ=g_{μ}_{ᵢ}(eᵢₖ−θᵢ),
wherein g_{μ}_{ᵢ}(x)=1/(1+e^{-μ}^{ᵢ}^{x}), eᵢₖ represents an expression level of the first gene gᵢ under condition k, and μᵢ and θᵢ represent parameters associated with the first gene gᵢ.

17. The method of claim 15, wherein determining the probability pᵢₖ includes calculating the probability pᵢₖ based on:
pᵢₖ=rᵢₖ^{μ}^{ᵢ}/(rᵢₖ^{μ}^{ᵢ}+cᵢₖ^{μ}^{ᵢ}e^{θ}^{ᵢ}^{μ}^{ᵢ}),
wherein rᵢₖ represents an expression level of the first gene gᵢ under condition k, cᵢₖ represents a control expression level of the first gene gᵢ under condition k, and μᵢ and θᵢ represent parameters associated with the first gene gᵢ.

18. The method of claim 15, further comprising:
calculating a 2×2 contingency table T_{ij,xy} based on:
$${T}_{i j , x y} = ( \begin{matrix}{\sum }_{k = 1}^{n} {q}_{i k} {q}_{j k} & {\sum }_{k = 1}^{n} {q}_{i k} {p}_{j k} \\ {\sum }_{k = 1}^{n} {p}_{i k} {q}_{j k} & {\sum }_{k = 1}^{n} {p}_{i k} {p}_{j k}\end{matrix} ) ,$$
wherein qᵢₖ=1−pᵢₖ, qⱼₖ=1−pⱼₖ, x ranges from 0 to 1, and y ranges from 0 to 1.

19. The method of claim 18, wherein deriving the mutual information M includes calculating the mutual information M based on:
$$\begin{matrix}M = {\sum }_{x = 0 , 1} {\sum }_{y = 0 , 1} {P}_{i j , xy} \times {log}_{2} \frac{{P}_{i j , x y}}{{P}_{i x} \times {P}_{j y}} , \\ \begin{matrix}wherein {P}_{i j , xy} = {T}_{i j , xy} / n , {P}_{i x} \\ = {\sum }_{y = 0 , 1} {T}_{i j , xy} / n ,\end{matrix} \\ and {P}_{j y} = {\sum }_{x = 0 , 1} {T}_{i j , xy} / n .\end{matrix}$$

20. A computer-readable medium, comprising:
code to determine, for each condition k of n conditions, a probability pᵢₖ of a first gene gᵢ being in its induced state and a probability pⱼₖ of a second gene gⱼ being in its induced state;
code to derive a contingency table for the first gene gᵢ and the second gene gⱼ based on the probabilities pᵢₖ and pⱼₖ;
code to derive a mutual information M for the first gene gᵢ and the second gene gⱼ based on the contingency table; and
code to cluster the first gene gᵢ and the second gene gⱼ based on the mutual information M as a metric.

21. The computer-readable medium of claim 20, wherein the code to determine the probability pᵢₖ includes code to calculate the probability pᵢₖ based on a probability function.

22. The computer-readable medium of claim 20, wherein the code determine the probability pᵢₖ includes code to calculate the probability pᵢₖ based on:
pᵢₖ=g_{μ}_{ᵢ}(eᵢₖ−θᵢ)
wherein g_{μ}_{ᵢ}(x)=1/(1+e^{-μ}^{ᵢ}^{x}), eᵢₖ represents an expression level of the first gene gᵢ under condition k, and μᵢ and θᵢ represent parameters associated with the first gene gᵢ.

23. The computer-readable medium of claim 20, wherein the code to determine the probability pᵢₖ includes code to calculate the probability pᵢₖ based on:
pᵢₖ=rᵢₖ^{μ}^{ᵢ}(rᵢₖ^{μ}^{ᵢ}+cᵢₖ^{μ}^{ᵢ}e^{θ}^{ᵢ}^{μ}^{ᵢ}),
wherein rᵢₖ represents an expression level of the first gene gᵢ under condition k, cᵢₖ represents a control expression level of the first gene gᵢ under condition k, and μᵢ and θᵢ represent parameters associated with the first gene gᵢ.

24. The computer-readable medium of claim 23, wherein μᵢ=1, and θᵢ=0.

25. The computer-readable medium of claim 20, wherein the code to derive the contingency table includes code to calculate a 2×2 contingency table T_{ij,xy} based on:
$${T}_{i j , x y} = ( \begin{matrix}{\sum }_{k = 1}^{n} {q}_{i k} {q}_{j k} & {\sum }_{k = 1}^{n} {q}_{i k} {p}_{j k} \\ {\sum }_{k = 1}^{n} {p}_{i k} {q}_{j k} & {\sum }_{k = 1}^{n} {p}_{i k} {p}_{j k}\end{matrix} ) ,$$
wherein qᵢₖ=1−pᵢₖ, qⱼₖ=1−pⱼₖ, x ranges from 0 to 1, and y ranges from 0 to 1.

26. The computer-readable medium of claim 20, further comprising:
code to receive hybridization data of a sample nucleic acid sequence and nucleic acid probes, wherein the code to determine the probability pᵢₖ includes code to calculate the probability pᵢₖ based on the hybridization data.

27. The computer-readable medium of claim 20, further comprising:
code to interface with a hypertext transfer protocol server.

28. The computer-readable medium of claim 20, further comprising:
code to generate a hypertext markup language document indicating the first gene gᵢ and the second gene gⱼ.
